(19) United States
(12) Patent Application Publication
(10) Pub. No.: US 2011/0061068 A1
(43) Pub. Date: Mar. 10, 2011

(54) TAGGING MEDIA WITH CATEGORIES

(76) Inventors: Rashad Mohammad Ali, Plano, TX (US); Gang Ho, Plano, TX (US)

(21) Appl. No.: 12/556,821

(22) Filed: Sep. 10, 2009

(51) Int. Cl. H04N 7/025; H04N 7/173; H04H 60/33; G06Q 30/00

(52) U.S. Cl. 725/9; 705/14.4; 725/32

(57) ABSTRACT

The present disclosure is directed to a system and method for tagging media. In some implementations a method includes receiving information identifying media requested by a user devices. a plurality of different tags assigned to the requested media are identified. The plurality of tags are transmitted to the user device for presenting the plurality of tags in connection with presenting the media. Each of the plurality of tags are associated with an element in the media and configured to retrieve secondary information in response to at least the user selecting the tag.

### TECHNICAL FIELD

This invention relates to presenting media and, more particularly, to tagging media with categories.

### BACKGROUND

Content delivery over the Internet, cable, satellite, and broadcast continues to improve every day. Users can receive e-mail, news, games, entertainment, music, books, and web pages. Users may also have access to a plethora of services such as maps, shopping links, images, blogs, local search, television guides, on-demand video, satellite images, group discussions, hosted content, and e-mail. While many of the content and/or services are free to users, such content and services are often accompanied by an advertisement (“ad”) that helps providers defray the cost of providing the content and services. In addition, the advertisement may also add value to the user experience.

### SUMMARY

The present disclosure is directed to a system and method for tagging media. In some implementations a method includes receiving information identifying media requested by a user devices. a plurality of different tags assigned to the requested media are identified. The plurality of tags are transmitted to the user device for presenting the plurality of tags in connection with presenting the media. Each of the plurality of tags are associated with an element in the media and configured to retrieve secondary information in response to at least the user selecting the tag.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 illustrates an example tag system in accordance with some implementations of the present disclosure;

FIGS. 2A and 2B illustrates example displays for presenting tags in connection with media;

FIG. 3 illustrates an example database schema associated with tagging media; and

FIG. 4 illustrates an example method for tracking tags presented in connection with multimedia.

Like reference symbols in the various drawings indicate like elements.

### DETAILED DESCRIPTION

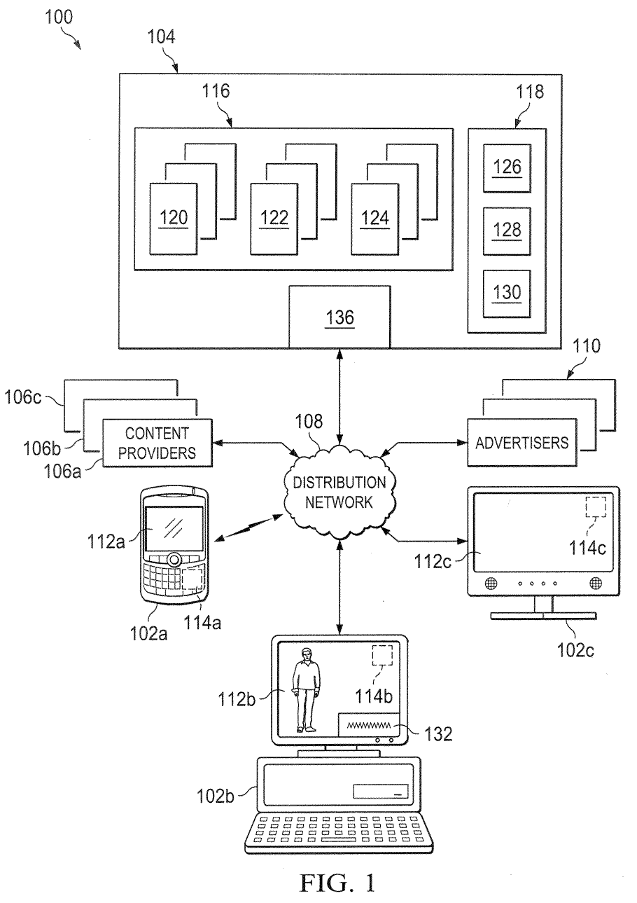

FIG. 1 illustrates an example tag system 100 for managing secondary content associated with presented media. For example, the tag system 100 may present tags in a hierarchy in connection with presenting a scene in multimedia (e.g., movie, video, music, conversation). A tag presented in connection with multimedia may include or otherwise identify one or more of the following: category, a Uniform Resource Locator (URL), a hyperlink, a vendor, a performer (e.g., actor, animal, animated character), a different video, audio (e.g., music), text, website, an item type, manufacturer, scene number/identifier, location, and/or other information. In some implementations, the tag system 100 may execute one or more of the following: identify multimedia available to the system 100; identify criteria for identifying tags and/or available tag space for scenes in the multimedia; receive bids from entities (e.g., company, advertiser) for at least a subset of the available tag space in scenes; receive tags from users identifying user-provided tags for scenes; aggregate tags for scenes in specific media based, at least in part, on assigned tags and/or user tags; transmit tags or at least information identifying a tag to a user device in response to at least user downloading associated multimedia; presenting the assigned tags in connection with presenting associated scenes in the multimedia; retrieving content (e.g., website, video, image) in response to at least a user selecting a presented tag; presenting the retrieved content through the user device to present secondary content associated with the scene; and/or others. In some implementations, a user may provided a tag for public and/or private use. In private-use case, the user may specify access to the tag based, at least in part, a user group, user selection, and/or other use defined aspects. Also in the case of user-provided tags, the tag file may be downloaded to a local machine. In some implementations, the system 100 may identify tags that direct viewers to secondary content associated with elements in a scene presented to a user. In some examples, the system 100 may present a hyperlink to a website that sells an item (e.g., clothing, jewelry) presented in a scene. In some examples, the system 100 may present a hyperlink to a fan website for an actor participating in a presented scene. By associating tags with multimedia, the system 100 may provide secondary content to users in connection with presenting the multimedia to the viewer.

In the illustrated implementation, the system 100 includes user devices 102a-c coupled to a tag server 104 and content providers 106a-c through a distribution network 108. The user devices 102a-c are electronic devices are owned, operated or otherwise associated with an individual and operable to at least receive multimedia from the content providers 106. The tag server 104 is an electronic device operable to determine or otherwise identify tags assigned to multimedia presented to a viewer using a user device 102 and transmit the tags to one or more of the user devices 102a-c to present to viewer in connection with presented the associated multimedia. The server 104 includes memory 116 and a processor 118. The memory 116 stores tag criteria 120 for identifying criteria to determine tag space available to multimedia from the content providers 106, target space 122 that identifies the tag space available to potential advertisers 110 and/or users, and tag files 124 that identifies tags assigned to multimedia. The processor 110 includes a tag engine 126 for determining or otherwise identifying tag space for multimedia based, at least part, on the tag criteria 120, an auction engine 128 for evaluating bids for tag space from the advertisers 110, and presentation engine 130 for presenting tags associated with multimedia using the tag files 124. At a high level of operation, the tag engine 126 retrieves or otherwise receives multimedia from the content provider 106 and evaluates the multimedia based, at least in part, on the tag criteria 120. In response to at least identifying one or more tag spaces for the multimedia, the tag engine 126 generates one or more tag-space files 122 identifying tag space available for the multimedia. The auction engine 128 evaluates bids from advertisers 110 for tag space identified in the tag-space files 122 for associated multimedia and assigns tags to the identified space based, at least in part, on the evaluated bids. The auction engine 128 generates one or more tag files 124 for the multimedia. In response to at least an event, the presentation engine 130 identifies one or more tag files 124 associated with requested multimedia and transmits the identified files 124 to the user device 102 for presentation through a Graphical User Interface (GUI) 112. While the illustrated implementation includes the single server 104, the system 100 may include any number of servers 104 communicably coupled to the network 1108. For example, the system 100 may include a server for generating auction tag spaces and a server for generating tag files 124.

Turning to a more detail description of the elements, each user devices 102a-c comprises electronic devices operable to process multimedia within system 100. As used in this disclosure, user devices 102 may include cellular phones, data phones, smart phones, soft phones, personal data assistants (PDAs), clients, televisions (TV), displays, computers, displays, media storage devices, audio systems, one or more processors within these or other devices, or any other suitable processing devices capable of processing multimedia in the system 100. In some implementations, the user devices 102 may use cellular radio technology (e.g., GSM) and/or unlicensed radio technology (e.g., UMA) to communicate multimedia. In some implementations, the media devices 102 may use broadband technologies (e.g., SIP) to transmit and/or receive media. In the illustrated implementation, the user devices 102a-c include a wireless device 102a, a client 102b, and a TV 120c. These specific implementations are for illustration purposes only, and the system 100 may include all, some, or none of these user devices 102 without departing from the scope of this disclosure. In short, the devices 102 generates requests, responses and/or otherwise communicate with content providers 106a-c through the network 108. In some implementations, the user devices 102a-c can present multimedia through GUIs 112a-c.

The GUI 112 comprises a graphical user interface operable to allow the user of the device 102 to interface with at least a portion of the system 100 for any suitable purpose, such as viewing multimedia. Generally, the GUI 112 provides the particular user with an efficient and user-friendly presentation of data provided by or communicated within the system 100. The GUI 112 may comprise a plurality of customizable frames or views having interactive fields, pull-down lists, and/or buttons operated by the user. The term graphical user interface may be used in the singular or in the plural to describe one or more graphical user interfaces and each of the displays of a particular graphical user interface. The GUI 112 can include any graphical user interface, such as a generic web browser or touch screen, that processes information in the system 100 and presents the results to the user. The content provider 106 can accept data from the device 102 using, for example, the web browser (e.g., Microsoft Internet Explorer or Mozilla Firefox) and return the appropriate responses (e.g., HTML or XML) to the browser using the network 108.

In some implementations, the tag modules 114a-c can include any software, hardware, and/or firmware for managing tags associated with displayed media. For example, the tag modules 114 may receive a plurality of tags for a media received from the content providers 106 and present the received tags in connection with presenting the media through the user device 102. In some implementations, the tag module 114 may receive information identifying tags for at least one of the scenes in the media and present the tags in a hierarchy in a window proximate to the displayed media. In some implementations, the tag module 114 may present one or more tags associated with at least one element in a scene in response to at least a user action. For example, the tag module 114 may present a tag proximate an element in a scene in response to at least a user overlaying a pointer on the element. For instance, the tag module 114 may present a tag, including a hyperlink, that identifies a manufacture of an element in a scene such the viewer is directed to a vendor website in response to at least the viewer selecting the tag. In some implementations, the tag module 114 may execute one or more of the following: receive from the tag server 104 information identifying tags for multimedia; identifying one or more events (e.g., scene, timestamp) in connection with presenting multimedia; presenting tags assigned to the presented scene in response to at least the one or more events; transmit a request for a webpage in response to at least a viewer selecting a presented tag; presenting the requested webpage to the viewer through the GUI 112. In some implementations, the user can view tags and/or tag media on the setbox such as Enhanced TV Binary Interchange Format (EBIF) or OpenCable Application Platform, or OCAP (OCAP) based setboxes.

As used in this disclosure, a user of client 102a is any person, department, organization, small business, enterprise, or any other entity that may use or request others to use system 100. Client 102a is intended to encompass a personal computer, touch screen terminal, workstation, network computer, a desktop, kiosk, wireless data port, smart phone, PDA, one or more processors within these or other devices, or any other suitable processing or electronic device used for viewing content from the server 104. For example, client 102a may be a PDA operable to wirelessly connect with an external or unsecured network. In another example, client 102a may comprise a laptop that includes an input device, such as a keypad, touch screen, mouse, or other device that can accept information, and an output device that conveys information associated with tags from target server 104, including digital data, visual information, or GUI 112. Both the input device and output device may include fixed or removable storage media such as a magnetic computer disk, CD-ROM, or other suitable media to both receive input from and provide output to users of clients 102 through the display such as GUI 112.

The television 102c generally includes an internal tuner and can further include any software, hardware, and/or firmware for displaying media to a viewer. In some implementations, the tuner in the television 102c may be a Phase Alternating Line (PAL) tuner, a National Television System Committee (NTSC) tuner, an Advanced Television Systems Committee (ATSC) tuner (or “HD” tuner), and so forth. For example, the television 102c may be an analog television set configured to receive analog signals through one or more inputs. Such inputs may include composite-video inputs, cable inputs, antennas, S-video inputs, RF-connector inputs, and others. The television 102c can also include, alternatively or in combination, digital inputs such as High-Definition Multimedia Interface (HDMI), Digital Visual Interface (DVI), or others. In the case of digital signals, the television 102c may include a converter (not illustrated) for converting digital signals to analog signals and/or may process digital signals in one or more native formats. To display images, the television 102c may include any of the following technologies: cathode-ray tube, rear projection, liquid crystals, plasma, Digital Light Processing (DLP), and others. In some cases, television 102c is located so that multiple viewers can view the presented materials, such as in a living room, TV room, bedroom, conference room, and so forth. As such, it should be noted that while generally described in terms of a “viewer,” any number of people may control or watch what is presented on their television 102c, perhaps via a remote control (not illustrated). In some implementations, the television 102c includes a GUI 112c enabling viewers to interact with the system 100.

Tag server 104 comprises an electronic computing device operable to receive, transmit, process and store data associated with system 100. System 100 can be implemented using computers other than servers, as well as a server pool. Indeed, tag server 104 may be any computer, electronic or processing device such as, for example, a blade server, general-purpose personal computer (PC), Macintosh, workstation, Unix-based computer, or any other suitable device. In other words, system 100 may include computers other than general purpose computers as well as computers without conventional operating systems. Tag server 104 may be adapted to execute any operating system including Linux, UNIX, Windows Server, or any other suitable operating system. In certain implementations, tag server 104 may also include or be communicably coupled with a web server and/or a mail server.

Tag server 104 includes memory 116 and a processor 118. Memory 116 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, memory 116 includes tag files 120, tracking files 122, and evaluation files 124, but may include other information without departing from the scope of this disclosure. Local memory 116 may also include any other appropriate data such as applications or services, firewall policies, a security or access log, print or other reporting files, HTML files or templates, data classes or object interfaces, child software applications or sub-systems, and others.

Tag files 120 include any parameters, pointers, variables, algorithms, instructions, rules, files, links, or other data that identifies tags associated presenting secondary content to viewers. As discussed above, the tag file 120 may include or otherwise identify one or more of the following attributes associated with media: media name, scene (e.g., chapter), scene length, character string identifying tag, content provider, genre, location in hierarchy, parent/child nodes, type of media (e.g., movie), duration, movie title, image name, television show, time, date, in-stream location, and/or other aspects associated with tagging media. In some examples, the tag file 120 may identify a movie, scene, item in the scene, manufacturer, vendor, URL, and other parameters associated with providing secondary information associated with media presented through user devices 102. In some examples, the tag file 120 may identify a sitcom, an in-stream location, date, time, jewelry in a scene, vendor, URL, and other parameters associated with the jewelry included in the scene of a sitcom. In some implementations, user may add tags to content presented through the televisions 102c using, for example, a remote control. In this case, the user may select a scene in a video using the remote control and type or otherwise generate the tag using the remote control. The module 114c may transmit the tag to the tag server 104 to update the associated tag file 120. Each tag file 120 may be associated with a specific content provider 106, specific media, a specific network, a specific video, and/or other aspects of system 100, and/or a plurality of tag files 120 may be associated with a single content provider 106, specific multimedia, a specific network, a specific video, and/or other aspect of the system 100. In some implementations, the tag files 120 may be formatted, stored, or defined as various data structures in text files, eXtensible Markup Language (XML) documents, Virtual Storage Access Method (VSAM) files, flat files, Btrieve files, comma-separated-value (CSV) files, internal variables, or one or more libraries. For example, a particular tag file 120 may merely be a pointer to a third party tag file stored remotely. In short, the tag files 120 may comprise one table or file or a plurality of tables or files stored on one computer or across a plurality of computers in any appropriate format. Indeed, some or all of tag file 120 may be local or remote without departing from the scope of this disclosure and store any type of appropriate data. In some implementations, the tracking file 120 may include or otherwise identify instructions for links presented trough the GUI 112.

The links 132 include any parameters, pointers, variables, algorithms, instructions, rules, files, links, source or object code, objects, directives, and/or other data for easily providing trackable secondary content (e.g., tags) for display through the GUI 112. In general, the links 132 may perform two functions: (1) presenting information to a viewer through the GUI 112 (e.g., character string); and (2) tracking actions associated with the presented information. As for the presented information, such links 132 may include (among other things) primary content, secondary content, and/or sponsored content. For example, each link 132 may be a text element, a graphics element, a multimedia element, and/or any other graphical or display element. In a more specific example, the link 132 may include an alphanumeric string identify aspects (e.g., item type, identifier, cost) of an item in a scene. As for tracking actions, the link 132 may comprise source or executable code that tracks action actions associated with the presented content. In some implementations, the link 132 can transmit information to the tag server 104 in response to at least the viewer selecting the link 132. In general, the link 132 may perform one or more of the following tracking functions: generate tracking information in response to viewer action; initiate transmission of a notification including tracking information; transmit a request to the network 108 for the website identified by the link; and/or other actions.

Tracking files 122 include one or more entries or data structures that identify information associated the tags display through the GUI 112 in the system 100. For example, the tracking files 122 may include or identify actions associated with the tags such as click-throughs. Tracking file 122 may be associated with a tag, multiple tags, a single advertiser 110, multiple advertisers 110, specific multimedia, a specific content provider 106 and/or other aspects or multiple tracking files 122 may be associated with a single content provider 106, a single advertiser 110, and/or a single video. In short, tracking files 122 may include or identify one or more of the following: network addresses associated with user devices 102, a number of click throughs, a number of conversions, a number of times presented, a time, a date, an advertiser, tag characteristics (e.g., string), manufacturer, vendor, website, content provider identifier, charges for advertisers, invoices, and/or any other suitable information for tracking actions associated with tags identified in the tag files 120.

Evaluation criteria 124 include any parameters, variables, algorithms, instructions, rules, objects or other directives for evaluating tags presented in multimedia. For example, evaluation criteria 124 may be used to evaluate tags based, at least in part, on conversions of tags presented through the GUI 112. Conversions may include one or more of the following: click throughs, revenue associated with tags, viewing time, and other interactions of a viewer associated with tags. At a high level, evaluation criteria 124 may include mathematical expressions for computing results (e.g., conversion rates) of the presented tags based on associated conversions, criteria for evaluating the results, and/or other aspects. In terms of computing results, evaluation criteria 124 may identify expressions to determine conversion rates such as click through rates (CTR), revenue per thousand tags (RPM), conversions per dollar (CPD), and/or other suitable results associated with presented tags. In addition to compute such parameters, the evaluation criteria 124 may identify mathematical and/or logical expressions for determining charges for presenting the tags in connection with the multimedia and determine charges for the advertisers 106 to present tags in connection with multimedia. For example, the evaluation criteria 124 may identify predefined rate per event (e.g., click throughs) and determine the charge to the advertiser based, at least in part, on the rate and the total number of click throughs.

Processor 118 executes instructions and manipulates data to perform operations of tag server 104. Although FIG. 1 illustrates a single processor 118 in tag server 104, multiple processors 118 may be used according to particular needs, and reference to processor 118 is meant to include multiple processors 118 where applicable. In the illustrated implementation, processor 118 executes request engine 126, the tracking engine 128, and the evaluation engine 130 at any appropriate time such as, for example, in response to a request or input from the content provider 106 or any appropriate computer system coupled with network 108. Request engine 126 includes any software, hardware, and/or firmware, or combination thereof, operable to retrieve and forward tags identified in tag files 120 based on media presented to the viewer. In the case of selecting an tag file 120, the request engine 126 may receive information from a user device 102 identifying media content requested from the content provider 106, identify one or more tag files 120 associated with the request media, and transmit information at least identifying the tags to the user device 102 for presenting the tags in connection with presenting the requested media. For instance, if the user device 102 may transmit information identifying a movie requested from the content provider 106 and, in response to at least the information, identify one or more tag files 120 associated with the request movie. In some implementations, the request engine 126 may identify one or more tags from the tag files 120 and transmit at least information identifying the tags to the user device 102.

Tracking engine 128 may track viewer actions to tags based on any suitable process. In general, tracking engine 128 may store information associated with tags transmitted to the user devices 102 and responses to the tags displayed through GUI 112. In connection with transmitting tags, tracking engine 128 may identify a tracking file 124 associated with one or more tags and store information in the tracking file 124. For example, the tracking engine 128 may store one or more of the following in tracking file 122: a network address associated with user device 102, a time, a date, a tag identifier, tag characteristics (e.g., string), an advertiser 110, request media, a tracking identifier, and/or any other suitable information for tracking actions associated with presented tags. As for the tracking identifier, the tracking engine 128 may store an identifier associated with a single tag in the tag file 120 and, in response to a user selecting the presented tag, store information identifying or otherwise associated with the selected tag in accordance with the identifier. In some implementations, the tracking identifier may be unique to the specific request. For example, the tracking identifier may based on the network address of user device 102, a date, and/or a time. In using a unique identifier, the tracking engine 128 may track specific instances of tags.

Evaluation engine 130 may evaluate viewer actions to tags based on any suitable process. For example, the evaluation engine 130 may determine chargers for advertisers based, at least in part, on tracking information and evaluation criteria 124. In some implementations, prior to evaluating the actions, evaluation engine 130 may perform a number of calculations based on the actions associated with the tags to determine one or more metrics. For example, the evaluation engine 130 may determine the number of specified conversions and/or conversion rates associated with each tag. Evaluation engine 130 may perform other calculations associated with attribute profiles such as RPM, CPD, and/or others. Evaluation engine 130 may retrieve or otherwise identify mathematical expressions in the evaluation criteria 124 for performing such calculations. In addition to perform calculations, the evaluation engine 130 may evaluate metrics associated with the tags using criteria included in the evaluation criteria 124. In evaluating these metrics, the evaluation engine 130 may use a mathematical and/or logical expressions. In addition to evaluating metrics, the evaluation engine 130 may automatically generate a notification to an associated advertiser 106 identifying a cost for presenting tags in connection with media. For example, the evaluation engine 130 may identify criteria included in evaluation criteria 124 and compare the criteria to specified metrics. In response to at least the one or more metrics of the presented satisfying the criteria, the evaluation engine 130 may automatically generate an invoice for the associated advertiser 110.

Regardless of the particular implementation, “software,” as used herein, may include software, firmware, wired or programmed hardware, or any combination thereof as appropriate. Indeed, request engine 126 and conversion engine 134 may be written or described in any appropriate computer language including C, C++, C#, Java, J#, Visual Basic, assembler, Perl, any suitable version of 4GL, as well as others. It will be understood that while request engine 126 and conversion engine 134 are illustrated in FIG. 1 as including individual modules, each of request engine 126 and conversion engine 134 may include numerous other sub-modules or may instead be a single multi-tasked module that implements the various features and functionality through various objects, methods, or other processes. Further, while illustrated as internal to server 104, one or more processes associated with request engine 126 and/or conversion engine 134 may be stored, referenced, or executed remotely. Moreover, request engine 126 and/or conversion engine 134 may be a child or sub-module of another software module or enterprise application (not illustrated) without departing from the scope of this disclosure.

Tag server 104 also includes interface 136 for communicating with other computer systems, such as publisher 104 and client 102, over network 108 in a client-server or other distributed environment. In certain implementations, tag server 104 receives data from internal or external senders through interface 136 for storage in local memory 116 and/or processing by processor 118. Generally, interface 136 comprises logic encoded in software and/or hardware in a suitable combination and operable to communicate with network 108. More specifically, interface 136 may comprise software supporting one or more communications protocols associated with communications network 108 or hardware operable to communicate physical signals.

Content providers 106a-c comprise various entities that serve network-based media such as video content. Specifically, each content provider 106 may employ, operate, own, control, lease, or otherwise be associated with an electronic device (e.g., computing device) that receives, transmits, processes, or stores such media content (e.g., video) for use by distributed users, such as the viewer. For example, the content provider 106 may be a television studio, movie studio, or an entity that operates on behalf of the studio such as a distributor, a data warehouse, an online video site (e.g., Netflix, YouTube), and/or any other suitable domain or web server. In another example, the content provider 106 may be the general online video site. In a further example, the content provider 106 may be an end user that publishes videos. In yet another example, the content provider 106 could be a news agency. Regardless of the particular entity, the content provider 106 may comprise a web server, a data warehouse, or any other computer device for storing or serving video over network 108. The provided video content may be in any suitable format such as MPEG, streaming, podcast, and so forth. In some implementations, the content provider 106 may distribute static content such as images, text (e.g., screenplay), and/or other content

Network 108 facilitates wireless or wired communication between tag server 104 and any other local or remote computer, such as user devices 102. For example, the network 108 may be a cable network, satellite network, IPTV network, the Internet, an enterprise network, and/or other networks. In some implementations, the network 108 may be all or a portion of an enterprise or secured network. While illustrated as single network, network 108 may be a continuous network logically divided into various sub-nets or virtual networks without departing from the scope of this disclosure, so long as at least a portion of network 108 may facilitate communications of tags and client data between tag server 104, content provider 106, and user devices 102. In some implementations, network 108 encompasses any internal or external network, networks, sub-network, or combination thereof operable to facilitate communications between various computing components in system 100. Network 108 may communicate, for example, Internet Protocol (IP) packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

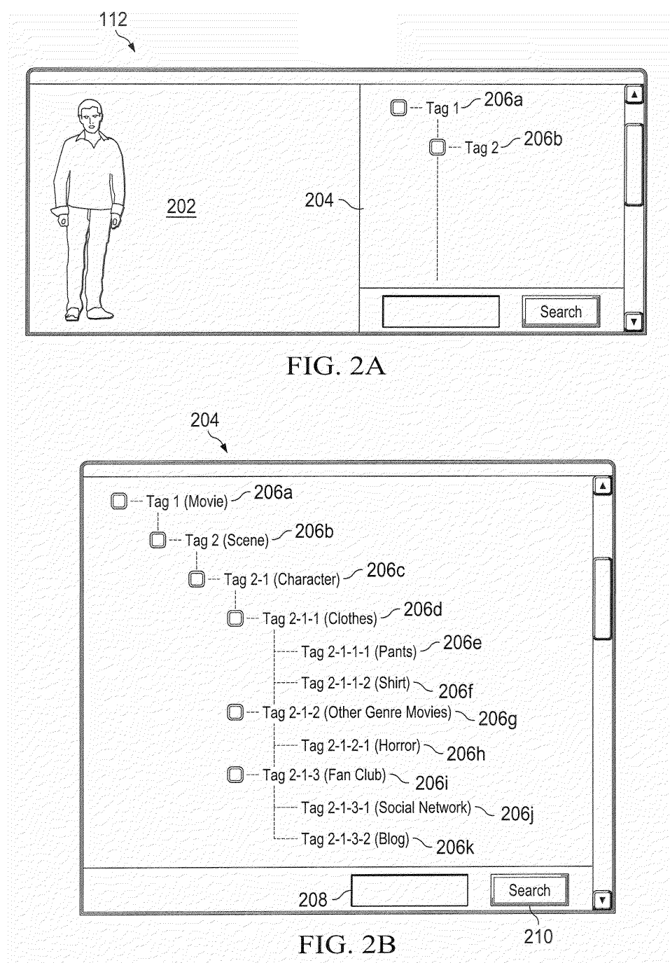

FIGS. 2A and 2B illustrate an example GUI 112 of FIG. 1 in accordance with some implementations of the present disclosure. In the illustrated implementation, the GUI includes a media display 202 and a tag display 204. The media display 202 presents media (e.g., video, screenplay) received from a content provider 106 through the GUI 112. The tag display 204 presents a plurality of tags 206a-k assigned to the presented media. In some implementations, the tag display 204 may present the plurality of tags 206 in a hierarchy including a root node and child nodes. As illustrated, the root node is the tag 206a assigned to the movie and the next node is the tag 206b assigned to the scene in the movie. For example, the node 206b may be assigned to the fourth scene in a movie. Child nodes of the scene node may be assigned to elements included in the scene. The elements may include an actor/actress, clothes, jewelry, location, and/or other aspects in the scene. In the illustrated implementation, the child node is assigned to the tag 206c for the character. In this instance, nodes below the character node are associated with different aspects of the particular character. For example, the display 204 includes a clothes tag 206d, an other-movies tag 206g, and a fan club tag 106i. A viewer of the display 204 may select the tag 206e to retrieve secondary information regarding the pants worn by the character in the scene. The illustrated hierarchy is illustration purposes only and the display 204 may include some, none, or all of the tags 206 without departing from the scope of the disclosure. In addition, the display 204 includes a search field 208 and a search button 210. A viewer may search different tags 206 associated with the presented content. For example, the viewer may search tags associated with a presented screenplay.

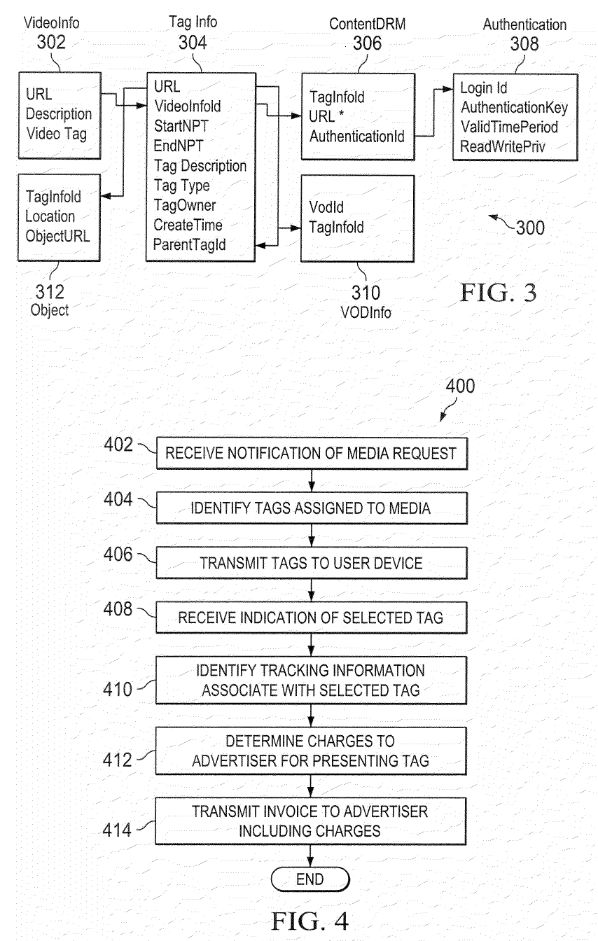

FIG. 3 illustrates an example database schema 300 for storing tag information associated with the system 100. In the example implementation, the schema 300 includes the follow submodules: videoinfo 302; taginfo 304; contentDRM 306; authentication 308; VODinfo 310; and object 312. The videoinfo 302 includes or otherwise identifies information associated with the video such as the URL, description and video tag. The taginfo 304 includes or otherwise identifies information associated with the tag such as the URL, the video in fold, start NPT, end NPT, tag description, tag type, tag owner, create time, and parent tag id. The contentDRM 306 includes or otherwise identifies information associated with DRM such as tag in fold, URL, and authentication. The authentication 308 includes or otherwise identifies information associated with authentication such as login id, authentication key, valid time period, and read/write privileges. The VODinfo 310 includes or otherwise identifies information associated with VOD such as vod id and tag in folder. The object 312 includes or otherwise identifies information associated with the object such as tag in folder, location, and object URL.

FIG. 4 is a flow diagram illustrating an example method 400 for presenting tags to viewers in connection with presented media. Generally, the method 400 describes an example technique for tracking user actions associated with tags. Method 400 contemplates using any appropriate combination and arrangement of logical elements implementing some or all of the described functionality.

The method 400 includes two high level processes: (1) tracking viewer activity from steps 402 to 406; and (2) evaluating the tracking information steps 408 to 414. Method 400 begins at step 402 where a notification indicating a media request is received. For example, the request engine 126 in FIG. 1 may receive information from the module 114 indicating that the viewer requested content (e.g., video, screenplay) from the content provider 106. At step 404, tags assigned to the requested media are identified. In the example, the request engine 126 may identify one or more tag files 120 associated with the requested video and identify one or more tags in the files 120 assigned to the request video. Next, at step 406, the identified tags are transmitted to the user device for presenting in connection with the requested media. Again in the example, the module 114 may present the assigned tags in a display (e.g., display 204) in connection with presenting the video through the GUI 112.

Turning to the second process, an indication that a presented tag was selected is received at step 408. As for the example, the tracking engine 128 may receive information identifying tag selected by a viewer through the GUI 112 and update an associated tracking file 122 with the information. At step 410, tracking information associated with the selected tag is identified. Again returning to the example, the evaluation engine 130 may identify, in files 122, tracking information associated with the selected tag in response to at least an event (e.g., number of conversions exceed threshold). Next, at step 412, charges to advertisers for presenting the tags are determined. In the example, the evaluation engine 130 may identify expressions in the evaluation criteria 124 and determine tag charges for the advertisers 106 based, at least in part, on the criteria and the tracking information. An invoice including the charges is transmitted to the advertiser at step 414. As for the example, the evaluation engine 130 may generate an invoice for the advertiser 110 that includes charges for presenting tags in connection with the video.

A number of implementations of the invention have been described. Nevertheless, it will be understood that various modifications may be made without departing from the spirit and scope of the invention. Accordingly, other implementations are within the scope of the following claims.

What is claimed is:

1. A method, comprising:
receiving information identifying media requested by a user devices;
identifying a plurality of different tags assigned to the requested media;
transmitting the plurality of tags to the user device for presenting the plurality of tags in connection with presenting the media, wherein each of the plurality of tags are associated with an element in the media and configured to retrieve secondary information in response to at least the user selecting the tag.

2. The method of claim 1, wherein the media is a video.

3. The method of claim 1, further comprising:
tracking user actions associated with at least one of the plurality of tags; and
determining one or more metrics for the at least one of the plurality of tags.

4. The method of claim 3, further comprising determining charges to an advertiser for presenting the at least one of the plurality of tags in connection with media.

5. The method of claim 4, wherein the one or more metrics comprises a click through rate.

6. The method of claim 1, wherein the plurality of tags comprise hyperlinks include different network addresses or web applications.

7. The method of claim 1, wherein the plurality of tags are presented to viewers in a hierarchy.

8. An article comprising a machine-readable medium storing instructions for providing business logic, the instructions operable to:
receive information identifying media requested by a user devices;
identify a plurality of different tags assigned to the requested media;
transmit the plurality of tags to the user device for presenting the plurality of tags in connection with presenting the media, wherein each of the plurality of tags are associated with an element in the media and configured to retrieve secondary information in response to at least the user selecting the tag.

9. The article of claim 8, wherein the media is a video.

10. The article of claim 8, further operable to:
track user actions associated with at least one of the plurality of tags; and
determine one or more metrics for the at least one of the plurality of tags.

11. The article of claim 10, further operable to determine charges to an advertiser for presenting the at least one of the plurality of tags in connection with media.

12. The article of claim 11, wherein the one or more metrics comprises a click through rate.

13. The article of claim 12, wherein the plurality of tags comprise hyperlinks to different network addresses or web applications.

14. The article of claim 12, wherein the plurality of tags are presented to viewers in a hierarchy.

15. A server for tracking advertisements comprising one or more processors operable to:
receive information identifying media requested by a user devices;
identify a plurality of different tags assigned to the requested media;
transmit the plurality of tags to the user device for presenting the plurality of tags in connection with presenting the media, wherein each of the plurality of tags are associated with an element in the media and configured to retrieve secondary information in response to at least the user selecting the tag.

16. The server of claim 15, wherein the media is a video.

17. The server of claim 15, further operable to:
track user actions associated with at least one of the plurality of tags; and
determine one or more metrics for the at least one of the plurality of tags.

18. The server of claim 17, further operable to determine charges to an advertiser for presenting the at least one of the plurality of tags in connection with media.

19. The server of claim 18, wherein the one or more metrics comprises a click through rate.

20. The server of claim 15, wherein the plurality of tags comprise hyperlinks to different websites.

21. The server of claim 15, wherein the plurality of tags are presented to viewers in a hierarchy.

22. A system, comprising:
a means for receiving information identifying media requested by a user devices;
a means for identifying a plurality of different tags assigned to the requested media;
a means for transmitting the plurality of tags to the user device for presenting the plurality of tags in connection with presenting the media, wherein each of the plurality of tags are associated with an element in the media and configured to retrieve secondary information in response to at least the user selecting the tag.
